(19) United States
(12) Patent Application Publication
(10) Pub. No.: US 2019/0126437 A1
(43) Pub. Date: May 2, 2019

(54) TRAY AND DISPLAY MODULE PRODUCTION APPARATUS USING THE SAME

(71) Applicants: BOE TECHNOLOGY GROUP CO., LTD., Beijing (CN); Hefei BOE Display Technology Co., Ltd., Hefei (CN)

(72) Inventors: Wei Min, Beijing (CN); Deng Pan, Beijing (CN); Zhenya Wang, Beijing (CN); Fan Peng, Beijing (CN); Jiange Feng, Beijing (CN)

(21) Appl. No.: 16/058,908

(22) Filed: Aug. 8, 2018

(30) Foreign Application Priority Data
Oct. 27, 2017 (CN) 201721409577.3

(51) Int. Cl. B25B 5/02; F16M 13/00

(52) U.S. Cl. CPC B25B 5/02; F16M 13/00

(57) ABSTRACT

A tray and a display module production apparatus using the same are provided. The tray includes a base, a main bracket and a limit bracket set. The main bracket includes a cross bar, which is connected with the base and is located above the base. The limit bracket set is connected to the cross bar. The limit bracket set includes a first bracket, a second bracket and at least one third bracket, and the first bracket and the second bracket are arranged in a longitudinal direction of the cross bar. A first limit portion is provided on the first bracket, and a second limit portion is provided on the second bracket. The third bracket is slidably mounted on the cross bar in the longitudinal direction of the cross bar. A third limit portion is provided on the third bracket. Limit directions of the first limit portion, the second limit portion and the third limit portion are different from each other.

### CROSS-REFERENCE TO RELATED APPLICATIONS

This application is based on and claims priority to Chinese Patent Application No. 201721409577.3, filed on Oct. 27, 2017, the entire contents thereof are incorporated herein by reference.

### TECHNICAL FIELD

The present disclosure relates to a tray and a display module production apparatus using the same.

### BACKGROUND

In the production process of a curved display screen, the aging process is required and the curved module product is placed in the tray for transportation to complete aging and detection. The tray is used to carry, transport and protect the curved module product. In the existing production process, the tray of the curved module product is usually in the form of clamping the left and right ends of the bracket with a support block adhered to the product therebehind. For the curved module product with different curvature, the support block has various positions and angles adhered with respect to the tray when placed on the tray. Therefore, when the curved module product with different curvature is produced, positions and angles of the support block in the tray are required to be adjusted, which takes time and manpower.

### SUMMARY

According to an aspect of the present disclosure, a tray is provided, which includes a base, a main bracket and a limit bracket set. The main bracket includes a cross bar, which is connected with the base and is located above the base. The limit bracket set is connected to the cross bar. The limit bracket set includes a first bracket, a second bracket and at least one third bracket, and the first bracket and the second bracket are arranged in a longitudinal direction of the cross bar. A first limit portion is provided on the first bracket, and a second limit portion is provided on the second bracket. The third bracket is slidably mounted on the cross bar in the longitudinal direction of the cross bar. A third limit portion is provided on the third bracket. Limit directions of the first limit portion, the second limit portion and the third limit portion are different from each other.

According to another aspect of the present disclosure, a display module production apparatus is provided, which includes the tray provided in any of the above technical solutions.

### BRIEF DESCRIPTION OF THE DRAWINGS

FIG. 1 is a schematic view of a tray according to an arrangement of the present disclosure; and

FIG. 2 is a schematic view of a display module production apparatus according to an arrangement of the present disclosure.

### DETAILED DESCRIPTION

The accompanying drawings, which are incorporated in the specification and constitute part of the present specification, show arrangements in accordance with the present disclosure, and explain principle of the present disclosure together with this specification. It is obvious for those ordinary skill in the art that the accompanying drawings in the following description are merely some arrangements of the present disclosure, and other drawings may also be obtained by these drawings without any creative work.

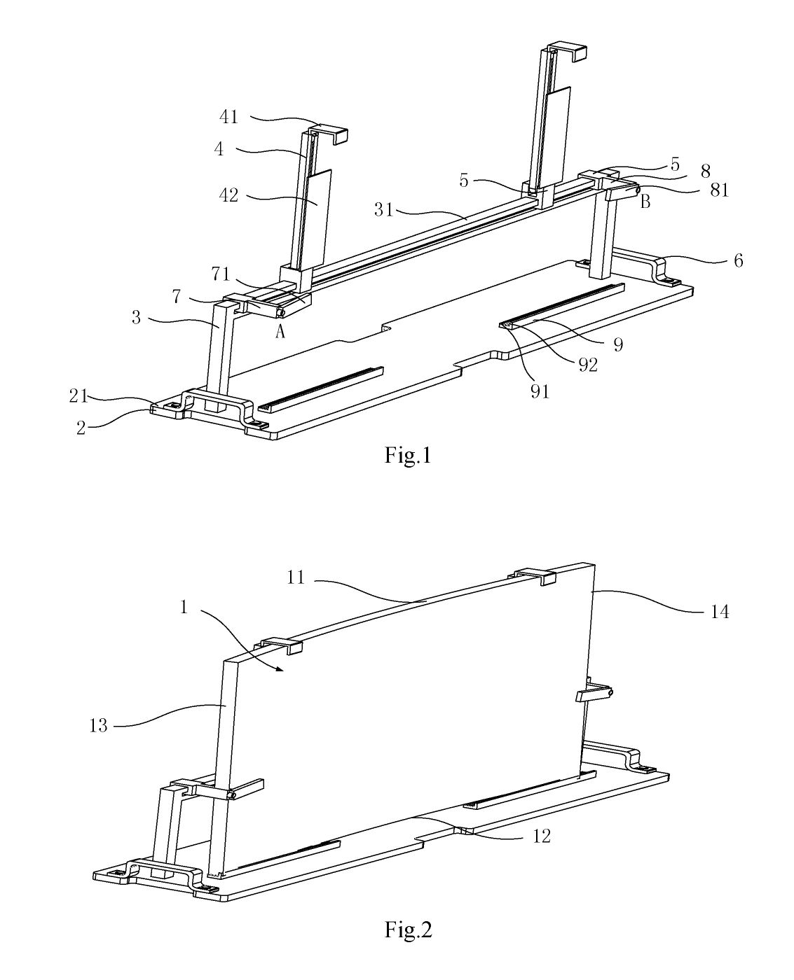

Referring to FIG. 1, an arrangement of the present disclosure provides a tray including a base 2, a main bracket 3 and a limit bracket set.

The main bracket 3 is connected to the base 2 and the main bracket 3 includes a cross bar 31 located above the base 2. The cross bar 31 is connected to the base 2 through sides of both ends thereof. The projection of the cross bar 31 on the base 2 is located on the upper surface 21 of the base 2.

The limit bracket set is connected to the cross bar 31. The limit bracket set includes a first bracket 7, a second bracket 8 and at least one third brackets 4. The first bracket 7 and the second bracket 8 are arranged in a longitudinal direction of the cross bar 31. A first limit portion 71 is provided on the first bracket 7, a second limit portion 81 is provided on the second bracket 8. The third bracket 4 is mounted to the cross bar 31 and can slide in the longitudinal direction of the cross bar 31. A third limit portion 41 is provided on the third bracket 4. Limit directions of the first limit portion 71, the second limit portion 81 and the third limit portion 41 are different from each other.

In the above-mentioned tray, various types of flat and curved display modules are stably supported in these three different limit directions by providing the slidable third bracket on the cross bar and providing the third limit portion on the third bracket combined with the first limit portion of the first bracket and the second limit portion of the second bracket. Therefore, the tray of the present disclosure can effectively fix various display modules.

In an arrangement of the present disclosure, the first bracket 7 and second bracket 8 are respectively located at two sides of the cross bar 31, and the first bracket 7 and the second bracket 8 are symmetrically disposed.

In an arrangement of the present disclosure, limit directions of the first limit portion 71, the second limit portion 81 and the third limit portion 41 are different. For example, as shown in FIG. 1, the first limit portion 71 forms a limit concave which is open to the right, the second limit portion 81 forms a limit concave which is open to the left, and the third limit portion forms a limit concave which is open downward.

The specific applications of the tray of the present disclosure will be further described below.

The tray of the present disclosure may be used to carry various display modules such as a flat surface display module, a curved surface display module and the like. In an arrangement of the present disclosure, the tray carrying the curved surface display module is taken as an example to illustrate a method for using the tray.

Based on FIG. 1 and referring to FIG. 2, the tray carries a curved surface display module 1. The curved surface display module 1 includes a first side 11 at top, a second side 12 at bottom, and a third side 13 and a fourth side 14 connected between the first side 11 and the second side 12. The first side 11 and the second side 12 are curved sides. The first side 11, the second side 12, the third side 13 and the fourth side 14 form an outer periphery of the curved surface display module 1. The curved surface display module 1 has two opposite surfaces. Specifically, the surface thereof adjacent to the cross bar 31 is defined as a back surface which is a convex surface, and the surface away from the cross bar 31 is defined as a front surface which is a concave surface.

An upper surface 21 of the base 2 serves as a bearing surface for supporting the second side 12 of the display module.

The first limit portion 71 on the first bracket 7 is used to limit the third side 13 of the curved surface display module 1, the second limit portion 81 on the second bracket 8 is used to limit the fourth side 14 of the curved surface display module 1, and the third limit portion 41 on the third bracket 4 is used to limit the first side 11 of the curved surface display module 1. The first bracket 7, the second bracket 8, a connection line between a connection end of the first bracket 7 and the first limit portion 71 and a connection end of the second bracket 8 and the second limit portion 81, and the cross bar 31 define an area. A projection of the third limit portion 41 is at least located within this area, and a surface of the third bracket 4 which is toward a connection line between the first limit portion 71 and the second limit portion 81 forms a support surface for supporting the back surface of the curved surface display module 1

Based on the above-mentioned structure, the base 2 provides a bottom support for the curved surface display module 1, the third limit portion 41 of the third bracket 4 provides a top support for the curved surface display module 1, the surface of the third bracket 4 toward the connection line between the first limit portion 71 and the second limit portion 81 forms a support surface for supporting the back surface of the curved surface display module 1 to provide a back support for the curved surface display module 1, and the first limit portion 71 of the first bracket 7 and the second limit portion 81 of the second bracket 8 provide support for two sides of the curved surface display module 1. Therefore, the tray of the present disclosure can effectively fix the curved surface display module 1. The third bracket 4 is slidably mounted to the cross bar 31 and can slide in the longitudinal direction of the cross bar 31. The position of the third bracket 4 is adjusted so that the third limit portion 41 is in full contact with the curved surface display module 1. The projection of the third limit portion 41 is located at an area defined by the first bracket 7, the second bracket 8, the connection line AB between the connection end of the first bracket 7 and the first limit portion 71 and the connection end of the second bracket 8 and the second limit portion 81, and the cross bar 31. Taking two products with the same size and different curvatures as an example, the product of larger curvature has a smaller length, so that, with respect to the product of smaller curvature, a distance between the first bracket 7 and the second bracket 8 is shorter, i.e. the connection line AB is shorter when carrying the product of larger curvature. A gap between two third brackets 4 is larger. An angle between a connection line between one of third brackets 4 and one end of the connection line AB and the connection line AB is defined. A distance between one of third brackets 4 and one end of the connection line AB is shorter than that between one of third brackets 4 and the other end of the connection line AB. The angle is larger when the curvature of the curved surface display module 1 is larger, and the angle is smaller when the curvature of the curved surface display module 1 is smaller. Therefore, the above-mentioned third bracket 4 may adapt to the curved surface display module 1 with different curvature so as to provide stable support.

In an arrangement of the present disclosure, the upper surface of the base 2 is also provided with at least one fourth limit portions 9, for example two. The fourth limit portion 9 is an L-shaped structure having a first support surface 91 parallel to the base 2 and a second support surface 92 perpendicular to the base. For example, the first support surface 91 is used to support the second side 12 of the curved surface display module 1, and the second support surface 92 is used to support the front of the curved surface display module 1. As the front of the curved surface display module is a curved surface, the second side is a curved side, and the first support surface 91 and the second support surface 92 are flat surfaces, therefore, the first support surface 91 and the second support surface 92 are not completely adhered to the second side 12 and the front of the curved surface display module 1, which are merely for providing point-support. The fourth limit portion 9 cooperates with the first limit portion 71, the second limit portion 81 and the third limit portion 41 to define the position of the curved surface display module 1. The fourth limit portion 9 functions as an auxiliary limit.

In an arrangement of the present disclosure, the first bracket 7 and/or the second bracket 8 may be slidably mounted to the cross bar 31 in the longitudinal direction of the cross bar 31.

In the above-mentioned tray, the first bracket 7 and/or the second bracket 8 may be slidably mounted to the cross bar 31 in the longitudinal direction of the cross bar 31 to facilitate to adjust the distance between the first bracket 7 and the second bracket 8 according to a width of the fixed curved surface display module 1, so that the curved surface display module 1 may be well fixed and thus the tray may adjust to the curved surface display module 1 with different width.

In an arrangement of the present disclosure, as shown in FIG. 1, the first bracket 7 may be slidably mounted to the cross bar 31 by a slider 5 in the longitudinal direction of the cross bar 31 and/or the second bracket 8 may be slidably mounted to the cross bar 31 by the slider 5 in the longitudinal direction of the cross bar 31.

In the above-mentioned tray, the first bracket 7 and/or the second bracket 8 is mounted on the cross bar 31 by the slider 5, and the mounting method is simple and convenient to adjust.

In an arrangement of the present disclosure, the first limit portion 71 is in a snap joint, and/or the second limit portion 81 is a snap joint, and/or the third limit portion 41 is a snap joint and the snap joint of the third limit portion 41 is slidably mounted to the third bracket 4 in the longitudinal direction of the third bracket 4.

The first limit portion 71 is a snap joint, and/or the second limit portion 81 is a snap joint so as to limit and fix sides of the curved surface display module 1 by the snap joint, which is simple and convenient to operate. The third limit portion 41 is a snap joint and the snap joint is slidably mounted to the third bracket 4 in the longitudinal direction of the third bracket 4 to facilitate to adjust the position of the third limit portion 41 according to the height of the curved surface display module 1, so that the curved surface display module 1 may be well fixed and thus the above-mentioned tray may adapt to the curved surface display module 1 with different height.

Specifically, the third limit portion 41 is a snap joint and the snap joint is slidably mounted to the third bracket 4 in the longitudinal direction of the third bracket 4. A sliding rail is provided on the third bracket 4 and the third limit portion 41 slides through a sliding rail in the longitudinal direction of the third bracket, so as to facilitate to adjust the position of the third limit portion 41.

In an arrangement of the present disclosure, each third bracket 4 is mounted to the cross bar 31 by the slider 5 and the third bracket 4 is movably connected with the slider 5.

The third bracket 4 may be folded on the cross bar 31 by movable connection such as shaft connection, ball connection and hinge connection when not in use, thus greatly saving storage space.

In an arrangement of the present disclosure, the third bracket 4 is mounted to the cross bar 31 by the slider 5 to facilitate to adjust the position of the third bracket 4 according to the curvature of the curved surface display module 1, so that the third bracket 4 may more securely fix the curved surface display module 1 and simultaneously the tray may adjust to the curved surface display module 1 with different curvature. The third bracket 4 is hinged with the slider 5. A hinge shaft is parallel to the bearing surface and is perpendicular to the longitudinal direction of the cross bar 31, the third bracket 4 is folded on the cross bar 31 by hinge connection when not in use, thus greatly saving storage space.

In an arrangement of the present disclosure, as shown in FIG. 1, each third bracket 4 is provided with a support pad 42 which faces away from the surface of the third bracket 4 to form a support surface.

Arranging the support pad 42 avoids the third bracket 4 directly contacting with the curved surface display module 1 to prevent the curved surface display module from being worn on the one hand, and on the other hand, the surface of the support pad 42 that faces away from the third bracket 4 forms a support surface. The support surface with different size may be provided for the curved surface display module 1 by changing the size of the support pad 42, and a larger support surface is provided for the curved surface display module 1 by suitably increasing the support pad 42 to provide a larger support surface and a better contact with the curved surface display module 1.

In an arrangement of the present disclosure, the support pad 42 is rotatably mounted to the third bracket 4 about an axis which is parallel to the longitudinal direction of the third bracket 4.

In an arrangement of the present disclosure, the support pad 42 is rotatably mounted to the rear bracket 4 in such a manner that the support pad 42 and the third bracket 4 are connected by a support block limit rotation mechanism, so as to facilitate to adjust the direction of the support block according to the curvature of the curved surface display module 1. The support pad 42 may automatically rotate within a certain range after contacting the curved surface display module 1 to ensure a best adhesion to the curved surface display module 1, so that the support surface of the support pad 42 may adhere to the back surface of the curved surface display module 1 to provide a better support.

In an arrangement of the present disclosure, as shown in FIG. 1, a handle 6 is provided on the base 2.

Providing the handle 6 on the base 2 may facilitate to transport the tray and adjust the position thereof.

In an arrangement of the present disclosure, as shown in FIG. 1, the third bracket 4 is provided as two.

Providing two third brackets 4 is more convenient to fix the curved surface display module 1 as it provides two back support surfaces and a top support, the curved surface display module 1 with different curvature is adapted by adjusting the distance between two third brackets 4.

In an arrangement of the present disclosure, a display module production apparatus is provided, which includes the tray provided in the above-mentioned technical solution such as an aging tray.

The display module production apparatus is suitable for production of the curved surface display module 1 with different curvature, has strong practicability and is convenient to adjust.

Although the above description is based on the curved surface display module as an example of application of the tray, those skilled in the art will readily understand that it can be used to carry the flat surface display module in a similar way.

It is apparent that those skilled in the art can make various modifications and variations to the arrangements of the present disclosure without departing from the spirit and scope of the disclosure. Thus, it is intended that the present disclosure will cover the modifications and variations if they belong to claims of the present disclosure and its equivalent technical scope.

What is claimed is:

1. A tray comprising:
a base;
a main bracket comprising a cross bar, the cross bar being connected with the base and being located above the base; and
a limit bracket set connected to the cross bar, the limit bracket set comprising a first bracket, a second bracket and at least one third bracket, the first bracket and the second bracket being arranged in a longitudinal direction of the cross bar, a first limit portion being provided on the first bracket, a second limit portion being provided on the second bracket; the third bracket being slidably mounted on the cross bar in the longitudinal direction of the cross bar, a third limit portion being provided on the third bracket, limit directions of the first limit portion, the second limit portion and the third limit portion are different from each other.

2. The tray according to claim 1, wherein at least one of the first bracket or the second bracket is slidably mounted to the cross bar in the longitudinal direction of the cross bar.

3. The tray according to claim 2, wherein the first bracket is slidably mounted to the cross bar by a slider in the longitudinal direction of at least one of the cross bar or the second bracket is slidably mounted to the cross bar by the slider in the longitudinal direction of the cross bar.

4. The tray according to claim 1, wherein the first limit portion and the second limit portion comprise a snap joint, or the third limit portion comprises a snap joint and the snap joint of the third limit portion is slidably mounted to the third bracket in a longitudinal direction of the third bracket.

5. The tray according to claim 1, wherein each of the at least one third bracket is mounted to the cross bar by a slider, and the at least one third bracket is movably connected with the slider.

6. The tray according to claim 1, wherein each of the third bracket is provided with a support pad, a surface of which faces away from the third bracket forms a support surface.

7. The tray according to claim 6, wherein the support pad is rotatably mounted to the third bracket about an axis which is parallel to a longitudinal direction of the third bracket.

8. The tray according to claim 1, wherein a handle is provided on the base.

9. The tray according to claim 1, wherein the third bracket is provided as two.

10. The tray according to claim 1, the tray being used to carry a display module, the display module comprising a first side at top, a second side at bottom, and a third side and a fourth side connected between the first side and the second side, the display module having a first surface and a second surface opposite to each other, wherein:
an upper surface of the base is configured as a bearing surface for supporting the second side of the display module;
the first limit portion on the first bracket limits the third side of the display module, the second limit portion on the second bracket limits the fourth side of the display module;
a third limit portion on the third bracket limits the first side of the display module, a surface of the third bracket towards a connection line between the first limit portion and the second limit portion supports the second surface of the display module.

11. The tray according to claim 10, wherein at least one fourth limit portion is provided on the upper surface of the base, the at least one fourth limit portion is configured to support the second side of the display module.

12. The tray according to claim 10, wherein the display module is a curved surface display module, the first side and the second side are curved sides, the first surface is a concave surface, and the second surface is a convex surface.

13. A display module production apparatus comprising:
a tray, wherein the tray comprises:
a base;
a main bracket comprising a cross bar, the cross bar being connected with the base and being located above the base; and
a limit bracket set connected to the cross bar, the limit bracket set comprising a first bracket, a second bracket and at least one third bracket, the first bracket and the second bracket being arranged in a longitudinal direction of the cross bar, a first limit portion being provided on the first bracket, a second limit portion being provided on the second bracket; the third bracket being slidably mounted on the cross bar in the longitudinal direction of the cross bar, a third limit portion being provided on the third bracket, limit directions of the first limit portion, the second limit portion and the third limit portion are different from each other.
